(19) United States
(12) Patent Application Publication
(10) Pub. No.: US 2025/0111629 A1
(43) Pub. Date: Apr. 3, 2025

(54) SIMULTANEOUS RENDERING OF MULTIPLE AVATARS

(71) Applicant: International Business Machines Corporation, Armonk, NY (US)

(72) Inventors: Charan Acharya Chandrashekar, Bangalore (IN); Hemant Kumar Sivaswamy, Pune (IN); Zachary A. Silverstein, Georgetown, TX (US)

(21) Appl. No.: 18/375,712

(22) Filed: Oct. 2, 2023

(51) Int. Cl. G06T 19/20; G06F 3/01; G06T 15/20

(52) U.S. Cl. CPC G06T 19/20; G06F 3/011; G06T 15/20; G06T 2219/024; G06T 2219/2021

(57) ABSTRACT

Requests are received from viewing users for rendering a virtual world in a computing environment that mimics real world, where at least one user appears in the virtual world. For each of the viewing users, a processor determines a group to which a viewing user belongs, determines a virtual representation of the at least one user that is mapped to the group, and renders the virtual representation of the at least one user in the virtual world to a device associated with the viewing user. Based on the determined mapping of the group to the virtual representation, the virtual representation of the at least one user rendered on the device associated with the viewing user appears at the same time differently from the virtual representation of the at least one user rendered on another device associated with another viewing user among the viewing users.

### BACKGROUND

The present application relates generally to computers and computer applications, and more particularly to simultaneous rendering of multiple avatars, for example, in environments such as in metaverse.

### BRIEF SUMMARY

The summary of the disclosure is given to aid understanding of a computer system and method of simultaneous rendering of multiple avatars, for example, in metaverse, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A computer-implemented method, in an aspect, includes receiving requests from a plurality of viewing users for rendering a virtual world in a computing environment that mimics real world, where at least one user appears in the virtual world. The method also includes, for each of the plurality of viewing users, determining a group to which a viewing user belongs, determining a virtual representation of the at least one user that is mapped to the group among multiple virtual representations of the at least one user, and rendering the virtual representation of the at least one user in the virtual world to a device associated with the viewing user. Based on the determined mapping of the group to the virtual representation, the virtual representation of the at least one user rendered on the device associated with the viewing user appears at the same time differently from the virtual representation of the at least one user rendered on another device associated with another viewing user of the plurality of viewing users.

A system, in an aspect, includes at least one computer processor. The system also include at least one memory device coupled with the at least one computer processor. The at least one computer processor is configured to receive requests from a plurality of viewing users for rendering a virtual world in a computing environment that mimics real world, where at least one user appears in the virtual world. The at least one computer processor is configured to, for each of the plurality of viewing users, determine a group to which a viewing user belongs, determine a virtual representation of the at least one user that is mapped to the group among multiple virtual representations of the at least one user, and render the virtual representation of the at least one user in the virtual world to a device associated with the viewing user. Based on the determined mapping of the group to the virtual representation, the virtual representation of the at least one user rendered on the device associated with the viewing user appears at the same time differently from the virtual representation of the at least one user rendered on another device associated with another viewing user of the plurality of viewing users.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a computing environment, which can implement simultaneous rendering of multiple avatars, for example, in metaverse, in some embodiments.

FIG. 2 shows a graphical depiction of different viewers viewing at the same time different avatars of a single user in some embodiments.

FIG. 3 shows a graphical depiction of a viewer at a location viewing avatars (different users) in some embodiments.

FIG. 4 is a flow diagram illustrating a method of setting up or configuring multiple avatars for rendering simultaneously to different viewers in some embodiments.

FIG. 5 is a flow diagram illustrating a method of rendering multiple avatars simultaneously to different viewers in some embodiments.

FIG. 6 is a flow diagram illustrating a method of simultaneous rendering of multiple avatars in an embodiment.

FIG. 7 is a diagram showing components of a system in some embodiments that simultaneously renders multiple avatars or virtual representations in virtual world.

### DETAILED DESCRIPTION

A computer-implemented method, in an aspect, includes receiving requests from a plurality of viewing users for rendering a virtual world in a computing environment that mimics real world, where at least one user appears in the virtual world. The method also includes, for each of the plurality of viewing users, determining a group to which a viewing user belongs, determining a virtual representation of the at least one user that is mapped to the group among multiple virtual representations of the at least one user, and rendering the virtual representation of the at least one user in the virtual world to a device associated with the viewing user. Based on the determined mapping of the group to the virtual representation, the virtual representation of the at least one user rendered on the device associated with the viewing user appears at the same time differently from the virtual representation of the at least one user rendered on another device associated with another viewing user of the plurality of viewing users. In this way, a user can appear differently based on which viewer is viewing the user in the virtual world such as metaverse.

One or more of the following features can be separable or optional from each other. In some embodiments, the determining of the group to which the viewing user belongs includes, responsive to determining that the viewing user does not belong to any group, determining that the viewing user belongs to a default group. In this way, for example, a viewing user who has not been assigned a specific group still sees some version of a virtual representation of the user.

In some embodiments, the determining of the group to which the viewing user belongs includes, responsive to determining that the viewing user belongs to a plurality of groups, determining that the viewing user belongs to a group associated with the virtual representation having a highest priority among the virtual representations of the at least one user, which are associated with the plurality of groups. In this way, a viewing user can belong to multiple groups such as “friend” and “family”, and which virtual representation that viewing user sees can be determined based on a priority setting among the virtual representations.

In some embodiments, the method also includes, based on a request from an owner of the virtual representation of the at least one user: creating groups and mapping the plurality of the viewing users to the groups; associating each of the groups to at least one virtual representation among the multiple representations of the at least one user, where a group among the groups is associated with a different virtual representation of the at least one user from another group among the groups; and storing in a database the mapping of the plurality of the viewing users to the groups and the associations of the groups to the virtual representations of the at least on user. In this way, for example, a user of the virtual world or metaverse can set up groups and virtual representations preferred by the user.

In some embodiments, the mapping of the plurality of the viewing users to the groups and the associations of the groups to the virtual representations of the at least one user are updated periodically. In this way, for example, dynamic updates can be made as to which viewing user sees (or is presented with) which virtual representation (e.g., avatar) of a user.

In some embodiments, the computer-implemented method further includes setting priority ranking to the virtual representations of the at least one user for rendering, where responsive to determining that the viewing user belongs to a plurality of groups, determining that the viewing user belongs to a group associated with the virtual representation having a highest priority among the virtual representations of the at least one user, which are associated with the plurality of groups. In this way, for example, conflicts as to which virtual representation to select can be resolved.

In some embodiments, for each of the plurality of viewing users, the determining of the virtual representation of the at least one user that is mapped to the group and the rendering of the virtual representation of the at least one user in the virtual world to the device associated with the viewing user, are performed with respect to all users in viewing range of the viewing user in the virtual world. In this way, for example, every user in the viewing range of the viewing user are given an option to present that user's preferred virtual representation to this specific viewing user.

A system including at least one computer processor and at least one memory device coupled with the at least one computer processor is also disclosed, where the at least one computer processor is configured to perform one or more methods described above. A computer program product is also disclosed that includes a computer readable storage medium having program instructions embodied therewith, where the program instructions are readable by a device to cause the device to perform one or more methods described above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as simultaneous rendering of multiple avatars algorithm code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

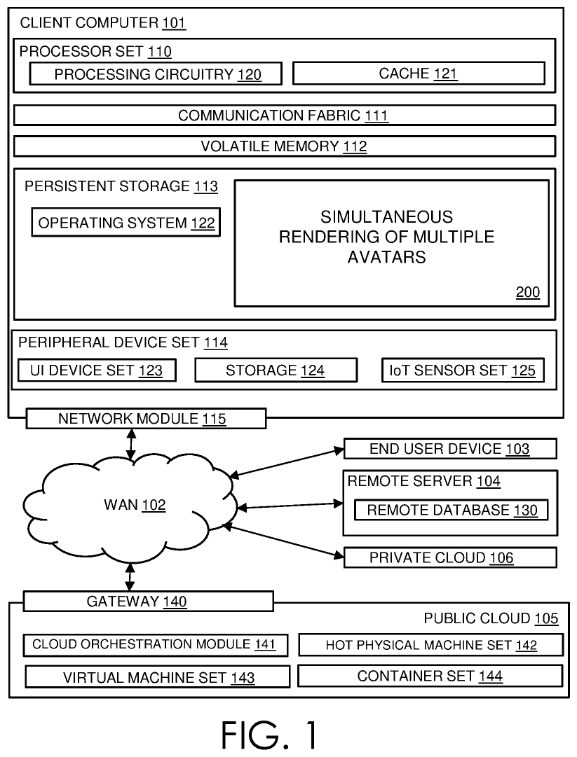

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A metaverse is a computer technology that provides an online 3-dimensional (3D_virtual world that mimics the real world, and uses techniques such as virtual reality (VR), augmented reality (AR), artificial intelligence (AI) and/or other computer techniques to provide users with a virtual experience. Users with internet connection can generally access such a virtual world, for example, using headsets or another device. Such technology allows users or players (e.g., of a computer game) to experience an immersive virtual world where the users can interact with one another and the virtual environment.

Avatar is a digital representation of a user, for example, a computer representation of a user in a computer-generated 3D world or a virtual world such as a metaverse. Using avatars or via avatars, users can interact with other users in such virtual world. Users can customize avatars to represent themselves. Avatars can have different characteristics, for example, in their appearance, behavior, and interactions with other users. For example, avatars can be programmed or created to have different visible attributes.

In some cases, a user may not want to appear the same to everyone in the metaverse. For example, a user may want to appear differently to different set audience for reasons such as security, creative expression, social or cultural norm and expectations, and/or other reasons. By way of example, a user may appear trendy to a set of friends while appearing professional in a professional setting to a set of colleagues.

Systems, methods and/or techniques are provided in one or more embodiments, which allow a user by way of avatars in a metaverse, to appear differently to different sets of audiences at the same time (e.g., simultaneously). For example, there can be multiple avatars representing the same user at the same time such that difference users, each of which, may view a different avatar of that user at the same time. A system and/or method for avatars to appear differently to different sets of users at the same time in metaverse can include an owner (or another user) of avatar creating a plurality of groups of users (viewers) and associating each group with an avatar. The system and/or method can also include receiving a request from a plurality of viewing users to see avatars. Metaverse server (or another computing device) can determine the viewer's group for each viewable avatar and render the determined avatar to viewer's device. In some embodiments, metaverse platform can receive a request from an owner or user of an avatar to create a plurality of groups, for example, by adding viewing users into the metaverse platform and associating each group with an avatar from an avatar set. In some embodiments, metaverse platform can verify the request and update an avatar management database with avatar-group mapping information. In some embodiments, metaverse platform can receive a request from a viewing user to view avatars within viewable range. Metaverse platform can determine a viewer's group for each of the viewable avatar, retrieving avatar-group mapping information from avatar management database and rendering the appropriate avatar to the viewer's device. In some embodiment, an owner or user of avatar can be allowed to set a default avatar for viewers who are not part of any defined or configured group. An owner or user of avatar can be allowed to set priority for avatar to be rendered in cases where viewers are part of multiple groups.

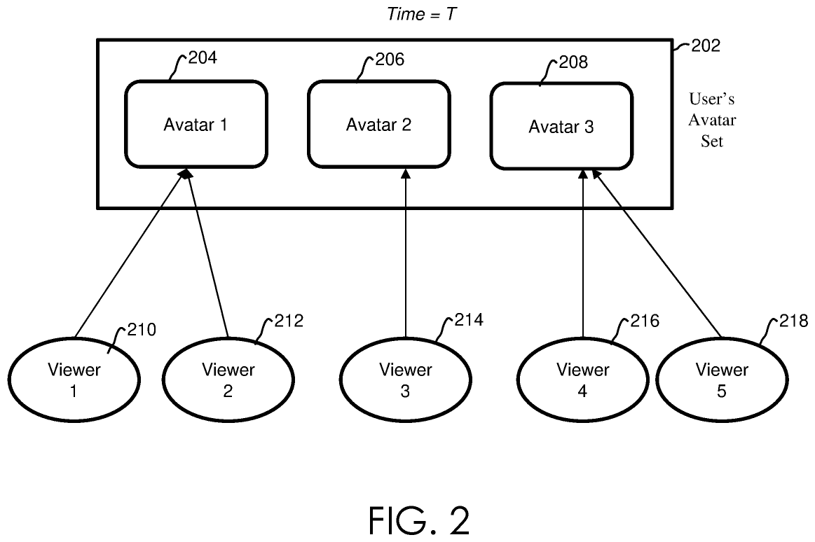

FIG. 2 shows a graphical depiction of different viewers viewing at the same time different avatars of a single user in some embodiments. A user, for example, a user of metaverse or virtual world, has a set of avatars (referred to as user's avatar set) 202. Each avatar 204, 206, 208 may have a different set of characteristics or attributes from another avatar in the set. A user, for example, can be given an option to be able to build characteristics or attributes for each avatar 204, 206, 208. Viewers 210, 212, 214, 216, 218 are associated with one or more groups. For example, a user can be given an option to create one or more groups and to place a viewer into one or more of the groups. A user can also be given an option to associate or link a group with one or more of the avatars 204, 206, 208 in the set of avatars 202. An avatar that is associated with a group in which a viewer belongs, is then rendered (e.g., displayed or presented) to that viewer. Different avatars can be rendered to different viewers at the same time, for example, based on the groupings of the viewers and associated avatars with the groups. For example, during time T, viewer 1 210 and viewer 2 212 see rendered avatar 1 204, viewer 3 214 sees rendered avatar 2 206, and viewer 4 216 and viewer 5 218 see rendered avatar 3 208.

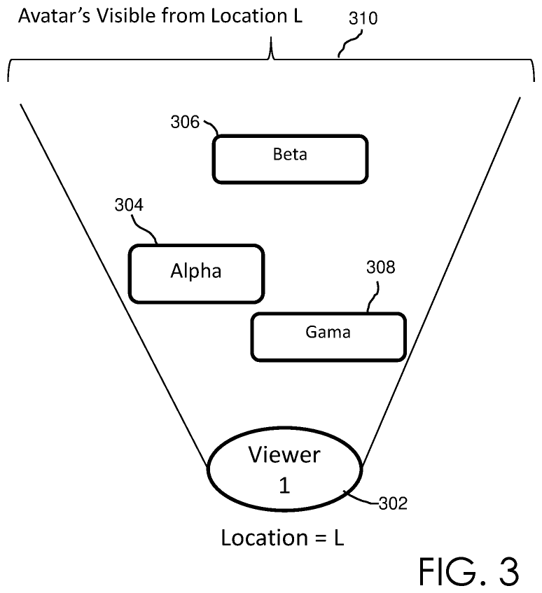

FIG. 3 shows a graphical depiction of a viewer at a location who are viewing avatars (virtual versions of different users) in some embodiments. For example, a viewing user (also referred to as a viewer) views, at a viewing location (for example, Location L), avatars of different users in metaverse, or virtual world. For instance, viewer 1 302 at Location L has a viewing range 310 of avatars 304, 306, 308.

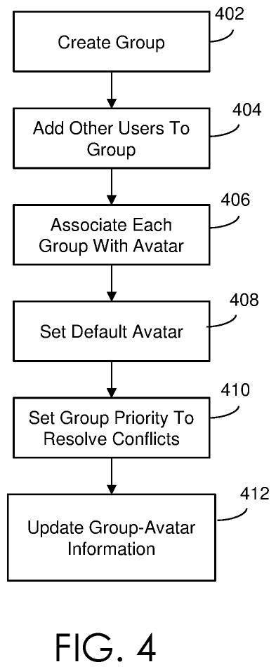

FIG. 4 is a flow diagram illustrating setting up or configuring multiple avatars for rendering simultaneously to different viewers in some embodiments. One or more hardware or computer processors, for example, which implement metaverse computing environment such as metaverse server, can run or implement the method. At 402, user is given an option to create groups. For example, user may create “friends” group, “family” group, and/or other groups, and may provide labels or names for the created groups.

At 404, user is also given an option to add other users into the groups, for example, as needed. For example, user may add another user as a friend in “friends” group. As another example, user may add user's family members to “family” group.

At 406, user is given an option to associate each of the group created at 402 with an avatar (e.g., one avatar) from the user's available set of avatars (also referred to as avatar set). For example, “friend” group is associated with Avatar A1, “family” group is associated with Avatar A2, and so forth.

At 408, user may assign a default avatar to one or more viewers who are not assigned into a group, for example, who are not part of any group. For example, user may set Avatar 3 as default avatar for viewers who are not part of any group. In such cases, some viewing users, which may include those not known to the user, who may be looking at the user will get to see the default avatar of the user.

Metaverse platform or server (e.g., one or more computer processors implementing metaverse or like computer virtual environment) may provide a user interface or like interface to allow users log in and perform the tasks described above, e.g., 402, 404, 406 and 408. Metaverse platform updates the information received from the user, e.g., via the processing at 402, 404, 406 and 408, such as the group-avatar mapping information in database, flat file, or another storage, e.g., based on the metaverse platform's implementation strategy.

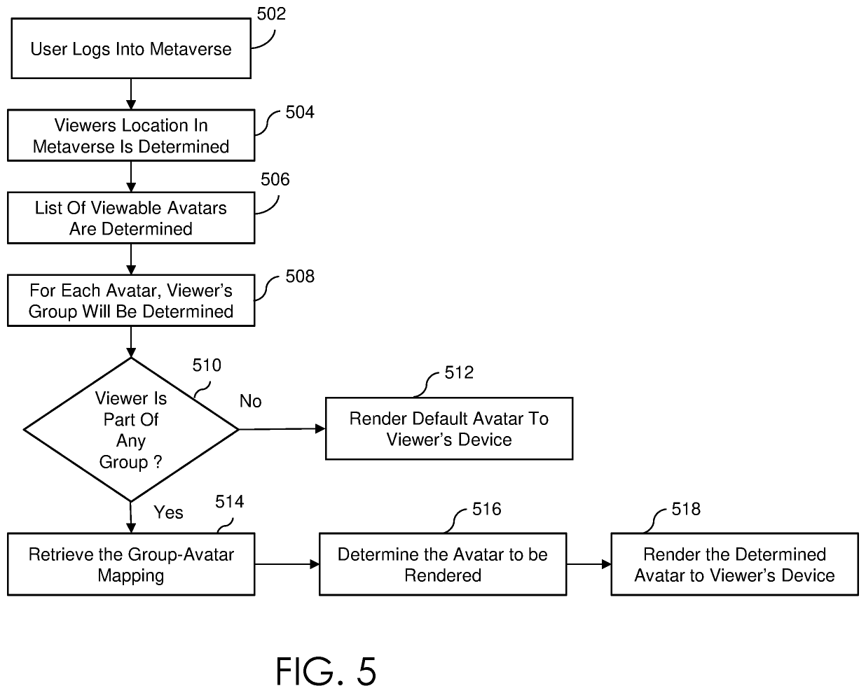

FIG. 5 is a flow diagram illustrating a method of rendering multiple avatars simultaneously to different viewers in some embodiments. One or more hardware or computer processors, for example, which implement metaverse computing environment such as metaverse server, can run or implement the method. At 502, viewer can log into metaverse or like computer virtual environment through a viewing device such as mobile, browser, virtual reality (VR) headset, and/or another device. Request is sent from viewer's device to metaverse (e.g., metaverse receives a request from a viewer's device) to view virtual objects based on viewer's location.

At 504, viewer's location in metaverse is determined. For example, metaverse utilizes spatial mapping to determine the list of avatars that are in viewable range of the viewer based on the viewer's location. For example, the viewer's current location in the virtual world or place represented by metaverse can be determined and a viewing range of the viewer is determined based on the viewer's eye range (or range of vision).

At 506, a list of viewable avatars are determined. For example, based on the location of the viewer determined at 504, avatars within the viewing rage of the viewer are determined.

At 508, for each of the avatar in the viewable or viewing range, metaverse identifies the group to which the viewer belongs.

At 510, if the viewer is determined not to be part of any group, at 512, default avatar is rendered to the viewer's device. For example, metaverse (e.g., server) renders a 3-dimensional (3D) object that is the default avatar and transmits the rendering to the viewer's device for presentation. For example, as described above, user has an option to set a default avatar for viewers who are not part of any group. For example, metaverse server may retrieve the default avatar specified by the user and saved in a database or another storage.

At 510, if the viewer is determined to belong to a group, at 514, group-avatar mapping information is retrieved, for example, from a database or another storage, based on the group to which the viewer belongs. At 516, avatar that is mapped to the group to which the viewer belongs is identified or determined based on the retrieved group-avatar mapping information.

At 518, the determined avatar is rendered to the viewer's device. For example, metaverse (e.g., server) renders a 3-dimensional (3D) object that is the determined avatar and transmits the rendering to the viewer's device for presentation.

In some embodiments, a viewer can be part of multiple groups, that is, belong to multiple groups. User can be given an option to set priority for groups to resolve conflicts when viewer is part of multiple groups. Such setting can be retrieved by the metaverse server and the prioritized avatar can be rendered to the viewer's device.

Table 1A and Table 1B show an example grouping information for an example user (e.g., User 1), where Table 1A provides username (potential viewers) to group name assignment, and Table 1B provides group name to avatar assignment. For instance, this example user has three different avatars, for example, A1, A2, and A3. Usernames (Viewer1, Viewer2, Viewer3) are mapped to groups (friend, family). Group names (friend, family, default) are mapped to avatars or avatar identifiers (A1, A2, A3).

TABLE 1A

| Username | Group name |
|---|---|
| Viewer1 | Friend |
| Viewer2 | Family |
| Viewer3 | Friend |

TABLE 1B

| Group name | Avatar |
|---|---|
| Friend | A1 |
| Family | A2 |
| Default | A3 |

Table 2A and Table 2B show an example grouping information for another example user (e.g., User 2), where Table 2A provides username (potential viewers) to group name assignment, and Table 2B provides group name to avatar assignment. For instance, this example user has four different avatars, for example, A4, A5, A6 and A7. Usernames (Viewer4, Viewer5, Viewer6) are mapped to groups (work, social1, social2). Group names (work, social1, social2, default) are mapped to avatars or avatar identifiers (A4, A5, A6, A7).

TABLE 2A

| Username | Group name |
|---|---|
| Viewer4 | Work |
| Viewer5 | Social1 |
| Viewer6 | Social2 |

TABLE 2B

| | Virtual Representation |
|---|---|
| Group name | (Avatar) |
| Work | A4 |
| Social1 | A5 |
| Social2 | A6 |
| Default | A7 |

As an example use case, avatars can be created that can be used in virtual meetings and conferences. Another use case can be in electronic or computer games.

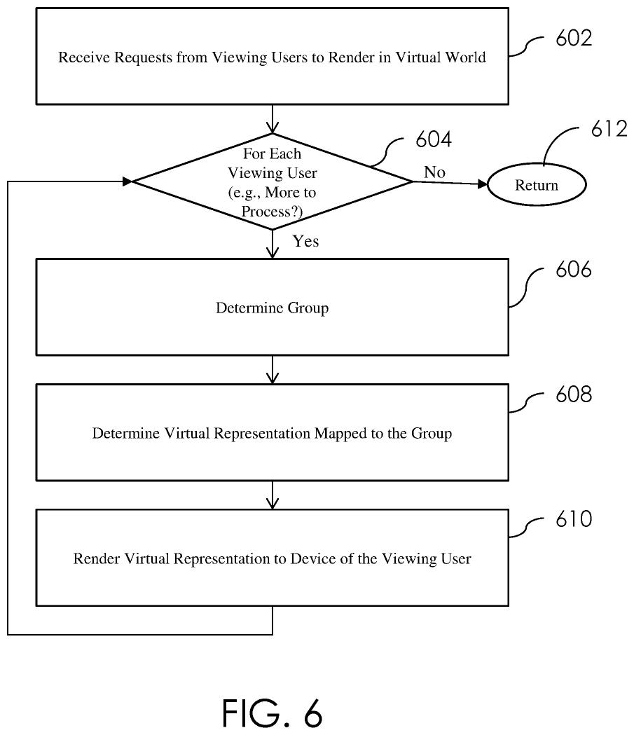

FIG. 6 is a flow diagram illustrating a method of simultaneous rendering of multiple avatars in an embodiment. As described above, avatars are virtual representations of a user (e.g., a person) in a virtual world in a computing environment, e.g., also known as metaverse. The method can be implemented by one or more computer processors. At 602, the method includes receiving requests from a plurality of viewing users for rendering a virtual world in a computing environment that mimics real world, where at least one user (e.g., a virtual representation of that user, e.g., an avatar) appears in the virtual world. Viewing users are also users of metaverse, e.g., as shown and described with respect to FIGS. 2 and 3.

Processing at 606, 608 and 610 are performed for each of the viewing users from whom requests are received. For example, as shown at 604, if there are viewing users to process, the processing proceeds to 606. Otherwise, the processing proceeds to 612.

At 606, the method includes determining a group to which a viewing user belongs. For example, a computer processor may access and retrieve information from a database such as described above and shown in Table 1A and Table 2A. In some embodiments, determining of the group to which the viewing user belongs includes, responsive to determining that the viewing user does not belong to any group, determining that the viewing user belongs to a default group. In this way, for example, a viewing user who has not been assigned a specific group still sees some version of a virtual representation of the user. In some embodiments, determining of the group to which the viewing user belongs includes, responsive to determining that the viewing user belongs to a plurality of groups (multiple groups), determining that the viewing user belongs to a group associated with a version of the virtual representation having a highest priority among versions of the virtual representation of the at least one user associated with the plurality of groups. In this way, a viewing user can belong to multiple groups such as “friend” and “family”, and which virtual representation that viewing user sees can be determined based on a priority setting among the virtual representations.

At 608, the method includes determining a virtual representation of the at least one user that is mapped to the group among multiple virtual representations of the at least one user. For example, a computer processor may access and retrieve information from a database such as described above and shown in Table 1B and Table 2B.

At 610, the method includes rendering the virtual representation of the at least one user in the virtual world to a device associated with the viewing user. For example, the virtual representation can be rendered digitally in 3D, and transmitted to a device of the viewing user for the viewing user's view.

The method proceeds to 604, where it is determined whether there are more viewing users to process. If so, the processing at 606, 608, 610 repeats for that viewing user. In this way, based on the determined mapping of the group to the virtual representation, the virtual representation of the at least one user rendered on the device associated with the viewing user appears differently at the same time from the virtual representation of the at least one user rendered on another device associated with another viewing user of the plurality of viewing users. For example, as shown and described with reference to FIG. 2, different avatars are rendered to different sets of viewing users, e.g., different avatars having different appearance characteristics or appearing differently.

In some embodiments, the method also includes, based on a request from an owner of the virtual representation of the at least one user, creating groups and mapping the plurality of the viewing users to the groups, associating each of the groups to at least one virtual representation among the multiple representations of the at least one user, where a group among the groups is associated with a different virtual representation of the at least one user from another group among the groups, storing in a database the mapping of the plurality of the viewing users to the groups and the associations of the groups to the virtual representations of the at least on user. In this way, a user of the virtual world or metaverse can set up groups and virtual representations preferred by the user.

In some embodiments, mapping of the plurality of the viewing users to the groups and the association of the groups to the virtual representation of the at least one user are updated periodically, for example, based on on-going requests from an owner of the virtual representations. In this way, for example, dynamic updates can be made as to which viewing user sees (or is presented with) which virtual representation (e.g., avatar) of a user.

In some embodiment, the method further include setting priority ranking to the virtual representation of the at least one user for rendering, where responsive to determining that the viewing user belongs to a plurality of groups, determining that the viewing user belongs to a group associated with the virtual representation having a highest priority among the virtual representation of the at least one user, which are associated with the plurality of groups. In this way, conflicts as to which virtual representation to select can be resolved.

In some embodiments, for each of the plurality of viewing users, determining of the virtual representation of the at least one user that is mapped to the group and rendering of the virtual representation of the at least one user in the virtual world to the device associated with the viewing user, are performed with respect to all users in viewing range of the viewing user in the virtual world. In this way, every user in the viewing range of the viewing user are given an option to present that user's preferred virtual representation to this specific viewing user.

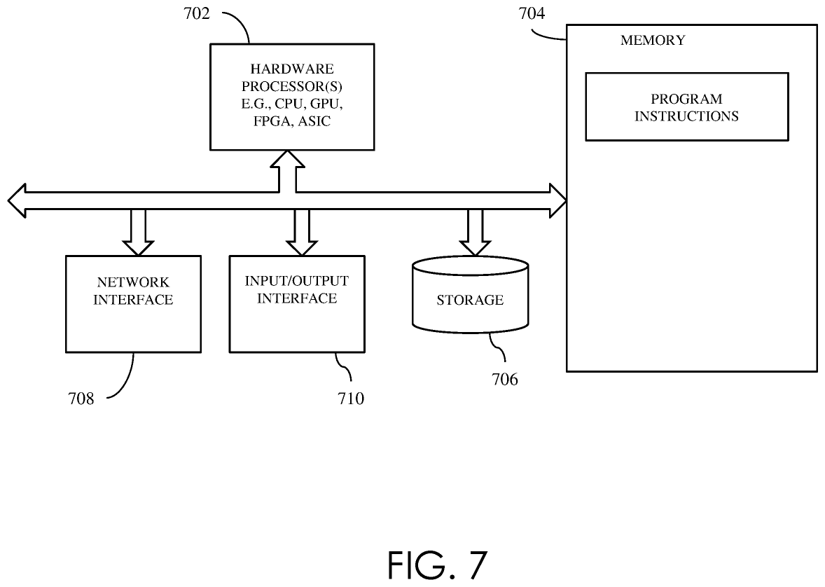

FIG. 7 is a diagram showing components of a system in some embodiments that simultaneously renders multiple avatars or virtual representations in virtual world. One or more hardware processors 702 such as a central processing unit (CPU), a graphic process unit (GPU), and/or a Field Programmable Gate Array (FPGA), an application specific integrated circuit (ASIC), and/or another processor, may be coupled with a memory device 704. A memory device 704 may include random access memory (RAM), read-only memory (ROM) or another memory device, and may store data and/or processor instructions for implementing various functionalities associated with the methods and/or systems described herein. One or more processors 702 may execute computer instructions stored in memory 704 or received from another computer device or medium. A memory device 704 may, for example, store instructions and/or data for functioning of one or more hardware processors 702, and may include an operating system and other program of instructions and/or data. One or more hardware processors 702 may receive requests from a plurality of viewing users for rendering a virtual world in a computing environment that mimics real world in a computing environment, where at least one user appears in the virtual world. For each of the plurality of viewing users, one or more hardware processors 702 may determine a group to which a viewing user belongs, determine a virtual representation of the at least one user that is mapped to the group among virtual representations of the at least one user, and render the virtual representation of the at least one user in the virtual world to a device associated with the viewing user. In this way, based on the determined mapping of the group to the virtual representation, the virtual representation of the at least one user rendered on the device associated with the viewing user appears at the same time differently from the virtual representation of the at least one user rendered on another device associated with another viewing user of the plurality of viewing users. Data used by one or more processors 702 may be stored in a storage device 706 or received via a network interface 708 from a remote device, and may be temporarily loaded into a memory device 704 for processing of simultaneous rendering of multiple avatars or virtual representations of a user. One or more hardware processors 702 may be coupled with interface devices such as a network interface 708 for communicating with remote systems, for example, via a network, and an input/output interface 710 for communicating with input and/or output devices such as a keyboard, mouse, display, and/or others.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in some embodiments” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
receiving requests from a plurality of viewing users for rendering a virtual world in a computing environment that mimics real world, wherein at least one user appears in the virtual world;
for each of the plurality of viewing users,
determining a group to which a viewing user belongs;
determining a virtual representation of the at least one user that is mapped to the group among multiple virtual representations of the at least one user; and
rendering the virtual representation of the at least one user in the virtual world to a device associated with the viewing user;
wherein based on the determined mapping of the group to the virtual representation, the virtual representation of the at least one user rendered on the device associated with the viewing user appears at the same time differently from the virtual representation of the at least one user rendered on another device associated with another viewing user of the plurality of viewing users.

2. The computer-implemented method of claim 1, wherein the determining of the group to which the viewing user belongs includes, responsive to determining that the viewing user does not belong to any group, determining that the viewing user belongs to a default group.

3. The computer-implemented method of claim 1, wherein the determining of the group to which the viewing user belongs includes, responsive to determining that the viewing user belongs to a plurality of groups, determining that the viewing user belongs to a group associated with the virtual representation having a highest priority among the virtual representations of the at least one user, which are associated with the plurality of groups.

4. The computer-implemented method of claim 1, further including, based on a request from an owner of the virtual representation of the at least one user:
creating groups and mapping the plurality of the viewing users to the groups;
associating each of the groups to at least one virtual representation among the multiple representations of the at least one user, wherein a group among the groups is associated with a different virtual representation of the at least one user from another group among the groups; and
storing in a database the mapping of the plurality of the viewing users to the groups and the associations of the groups to the virtual representations of the at least on user.

5. The computer-implemented method of claim 4, wherein the mapping of the plurality of the viewing users to the groups and the associations of the groups to the virtual representations of the at least on user are updated periodically.

6. The computer-implemented method of claim 4, further including setting priority ranking to the virtual representations of the at least one user for rendering, wherein responsive to determining that the viewing user belongs to a plurality of groups, determining that the viewing user belongs to a group associated with the virtual representation having a highest priority among the virtual representations of the at least one user, which are associated with the plurality of groups.

7. The computer-implemented method of claim 1, wherein for each of the plurality of viewing users, the determining of the virtual representation of the at least one user that is mapped to the group and the rendering of the virtual representation of the at least one user in the virtual world to the device associated with the viewing user, are performed with respect to all users in viewing range of the viewing user in the virtual world.

8. A computer program product comprising a computer readable storage medium having program instructions embodied therewith, the program instructions readable by a device to cause the device to:
receive requests from a plurality of viewing users for rendering a virtual world in a computing environment that mimics real world, wherein at least one user appears in the virtual world;
for each of the plurality of viewing users,
determine a group to which a viewing user belongs;
determine a virtual representation of the at least one user that is mapped to the group among multiple virtual representations of the at least one user; and
render the virtual representation of the at least one user in the virtual world to a device associated with the viewing user;
wherein based on the determined mapping of the group to the virtual representation, the virtual representation of the at least one user rendered on the device associated with the viewing user appears at the same time differently from the virtual representation of the at least one user rendered on another device associated with another viewing user of the plurality of viewing users.

9. The computer program product of claim 8, wherein in determining the group to which the viewing user belongs, the device is caused to: responsive to determining that the viewing user does not belong to any group, determine that the viewing user belongs to a default group.

10. The computer program product of claim 8, wherein in determining the group to which the viewing user belongs, the device is caused to: responsive to determining that the viewing user belongs to a plurality of groups, determine that the viewing user belongs to a group associated with the virtual representation having a highest priority among the virtual representations of the at least one user, which are associated with the plurality of groups.

11. The computer program product of claim 8, wherein the device is further caused to, based on a request from an owner of the virtual representation of the at least one user:
create groups and map the plurality of the viewing users to the groups;
associate each of the groups to at least one virtual representation among the multiple representations of the at least one user, wherein a group among the groups is associated with a different virtual representation of the at least one user from another group among the groups; and
store in a database mapping of the plurality of the viewing users to the groups and the associations of groups to the virtual representations of the at least on user.

12. The computer program product of claim 11, wherein the device is further caused to periodically update the mapping of the plurality of the viewing users to the groups and the associations of the groups to the virtual representations of the at least on user.

13. The computer program product of claim 11, wherein the device is further caused to set priority ranking to the virtual representations of the at least one user for rendering, wherein responsive to determining that the viewing user belongs to a plurality of groups, the device is caused to determine that the viewing user belongs to a group associated with the virtual representation having a highest priority among the virtual representation of the at least one user, which are associated with the plurality of groups.

14. The computer program product of claim 8, wherein for each of the plurality of viewing users, determining of the virtual representation of the at least one user that is mapped to the group and rendering of the virtual representation of the at least one user in the virtual world to the device associated with the viewing user, are performed with respect to all users in viewing range of the viewing user in the virtual world.

15. A system comprising:
at least one computer processor; and
at least one memory device coupled with the at least one computer processor;
the at least one computer processor configured to at least:
receive requests from a plurality of viewing users for rendering a virtual world in a computing environment that mimics real world, wherein at least one user appears in the virtual world;
for each of the plurality of viewing users,
determine a group to which a viewing user belongs;
determine a virtual representation of the at least one user that is mapped to the group among multiple virtual representations of the at least one user; and
render the virtual representation of the at least one user in the virtual world to a device associated with the viewing user;
wherein based on the determined mapping of the group to the virtual representation, the virtual representation of the at least one user rendered on the device associated with the viewing user appears at the same time differently from the virtual representation of the at least one user rendered on another device associated with another viewing user of the plurality of viewing users.

16. The system of claim 15, wherein in determining the group to which the viewing user belongs, the computer processor is configured to:
responsive to determining that the viewing user does not belong to any group, determine that the viewing user belongs to a default group.

17. The system of claim 15, wherein in determining the group to which the viewing user belongs, the computer processor is configured to:
responsive to determining that the viewing user belongs to a plurality of groups, determine that the viewing user belongs to a group associated with the virtual representation having a highest priority among the virtual representations of the at least one user, which are associated with the plurality of groups.

18. The system of claim 15, wherein the computer processor is further configured to, based on a request from an owner of the virtual representation of the at least one user:
create groups and map the plurality of the viewing users to the groups;
associate each of the groups to at least one virtual representation among the multiple representations of the at least one user, wherein a group among the groups is associated with a different virtual representation of the at least one user from another group among the groups; and
store in a database mapping of the plurality of the viewing users to the groups and the associations of the groups to the virtual representations of the at least on user.

19. The system of claim 18, wherein the computer processor is further configured to periodically update the mapping of the plurality of the viewing users to the groups and the associations of the groups to the virtual representations of the at least on user.

20. The system of claim 18, wherein the computer processor is further configured to set priority ranking to the virtual representations of the at least one user for rendering, wherein responsive to determining that the viewing user belongs to a plurality of groups, the computer processor is configured to determine that the viewing user belongs to a group associated with the virtual representation having a highest priority among the virtual representations of the at least one user, which are associated with the plurality of groups.
